(19) United States
(12) Patent Application Publication
(10) Pub. No.: US 2002/0000407 A1
(43) Pub. Date: Jan. 3, 2002

(54) Filter element

(75) Inventor: Kurt Seiler, Kraichtal (DE)

Correspondence Address: LAW OFFICE OF BARRY R LIPSITZ, 755 MAIN STREET, MONROE, CT, 06468, US

(73) Assignee: ARGO GmbH Fuer Fluidtechnik, Kraichtal (DE)

(21) Appl. No.: 09/837,870

(22) Filed: Apr. 18, 2001

(30) Foreign Application Priority Data
Apr. 19, 2000 (DE) 100 19 397.8

(51) Int. Cl. B01D 29/33

(52) U.S. Cl. 210/457

(57) ABSTRACT

In order to further develop a filter element, in particular for the filtration of mineral oils in hydraulic systems, having a filter material and a support tube which supports the filter material and is formed from a perforated plate with a multiplicity of flow openings, in such a manner that it is highly mechanically stable and can be produced at low cost, it is proposed, according to the invention, that the support tube has a joint which extends helically along the support-tube wall and is formed by those edges of the perforated plate which are in contact with one another in the circumferential direction.

The invention relates to a filter element, in particular for the filtration of mineral oils in hydraulic systems, having a filter material and a support tube which supports the filter material and is formed from a perforated plate with a multiplicity of flow openings.

Filter elements of this type are in general use for the filtration of fluids, in particular of mineral oils in hydraulic systems. The filter material used is generally a filter bellows which may, for example, be folded from a filter paper. The filter bellows is provided in the form of a hollow cylinder and the fluid to be filtered flows through it in the radial direction. The support tube, against the wall of which the filter material rests, is used as a support for the filter material. Depending on the direction of flow of the fluid to be filtered, the support tube may be arranged on the inside or the outside of the filter material, which is in the form of a hollow cylinder.

The support tube is usually formed from a perforated plate with a multiplicity of flow openings. For this purpose, it is customary for the perforated plate, in the form of a rectangular blank, to be rolled up and then for those longitudinal edges of the perforated plate which are in contact with one another to be welded together, in order to ensure that the support tube formed in this way can withstand the pressure drop which occurs at the filter element when the filter element is used in hydraulic systems.

The filter elements referred to above are in widespread use in practice but do entail not inconsiderable production costs. Moreover, there is a risk of the support tube used buckling at the weld seam if it is subjected to a high mechanical load.

It is an object of the present invention to further develop a filter element of the type described in the introduction in such a manner that it is highly mechanically stable and can be produced at low cost.

With a filter element of the generic type, this object is achieved, according to the invention, in that the support tube has a joint which extends helically along the support-tube wall and is formed by those edges of the perforated plate which are in contact with one another in the circumferential direction.

Unlike the usual design of the support tube with a weld seam which extends parallel to the longitudinal axis of the filter element, in the filter element according to the invention it is provided that the longitudinal edges of the rolled-up perforated plate form a helical joint. It has been found that with a configuration of this nature it is possible to provide a support tube for the filter element which is able to withstand even high pressures without the longitudinal edges of the perforated plate which has been rolled up to form the support tube having to be welded together. Rather, it is sufficient if the longitudinal edges of the perforated plate which has been rolled up to form the support tube remain without a weld seam, provided only that it is ensured that the joint formed in this way extends helically along the support-tube wall.

To produce the support tube used in the filter element according to the invention, it is simply necessary for the perforated plate to be cut into, for example, a parallelogram shape and then to be rolled up. Since there is no need to weld the perforated plate, the filter element according to the invention is distinguished by lower production costs, yet the helical configuration of the joint ensures that the filter element is able to withstand even high hydraulic pressures.

As has already been mentioned in the introduction, a filter paper which is folded into a filter bellows is usually used as filter material. The configuration according to the invention in this case results in the further advantage that the region in which the longitudinal folds of the filter material come into contact with the joint of the support tube is distributed over numerous longitudinal folds, on account of the helical profile of the joint. The result is improved stability of the folds under pressure loading, in particular in the event of pressure fluctuations.

To achieve a particularly high stability of the filter element, it is advantageous if the joint extends only over a partial region of the circumference of the support tube. In this context, it is particularly advantageous if the joint extends over at most half the circumference of the support tube, preferably over approximately a third of the circumference.

In a particularly preferred embodiment, it is provided that the edges of the perforated plate are in contact with one another without overlapping. A configuration of this type has proven particularly successful if the filter element is arranged on the outside of the support tube and flow is in the radial direction from the outside inwards. With an arrangement of this type, the support tube is exposed to a compressive load. As a result of an overlap of the perforated plate in the region of the joint being avoided, under a load of this type it is ensured that the longitudinal edges can be supported against one another.

In order, with greater pressure differences, to counteract axial displacement of the joint, it is appropriate if the pitch of the helical joint is partly left-handed and partly right-handed. A configuration of this nature can be achieved in a simple manner by the fact that the perforated plate is cut into the shape of an arrow and is then rolled up.

The following description of preferred embodiments of the invention in conjunction with the drawing serves the purpose of further explanation. In the drawing:

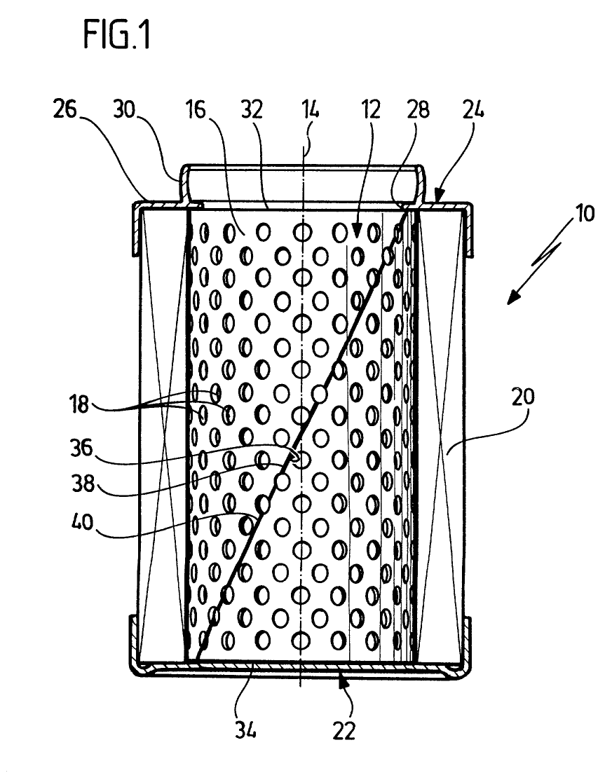

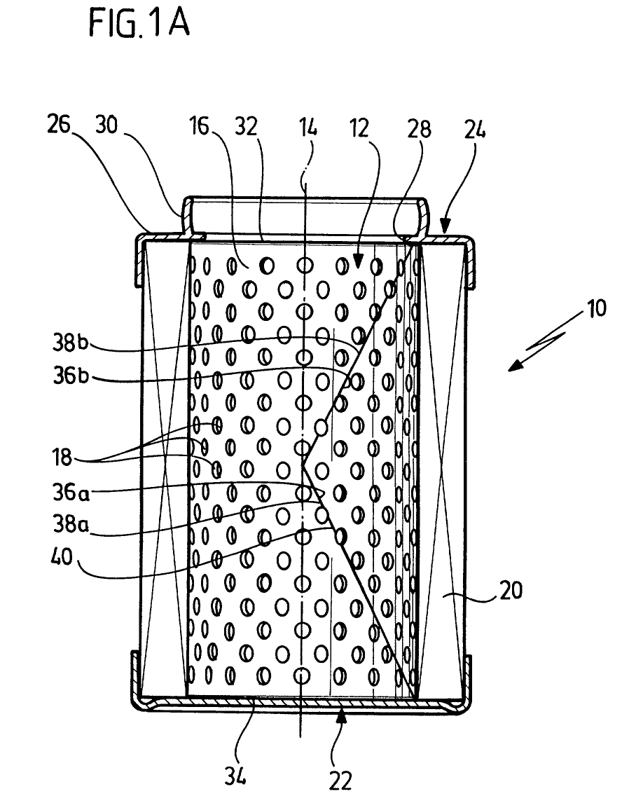

FIG. 1 shows a side view of a first embodiment of a filter element with a support tube formed from a parallelogram-shaped perforated plate;

FIG. 1A shows a side view of a second embodiment of a filter element with a support tube formed from an arrow-shaped perforated plate;

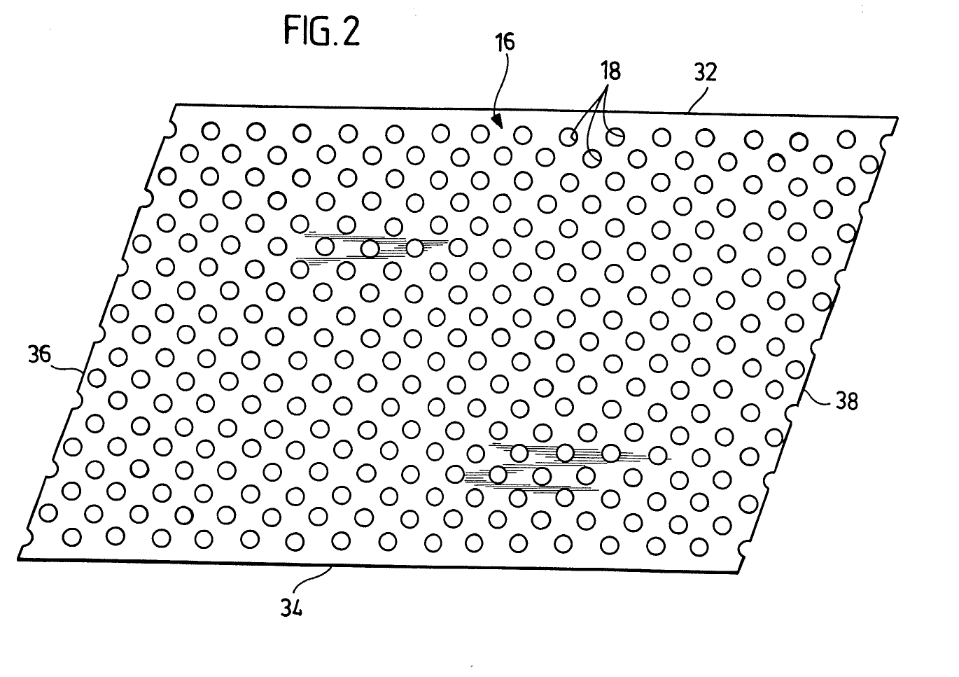

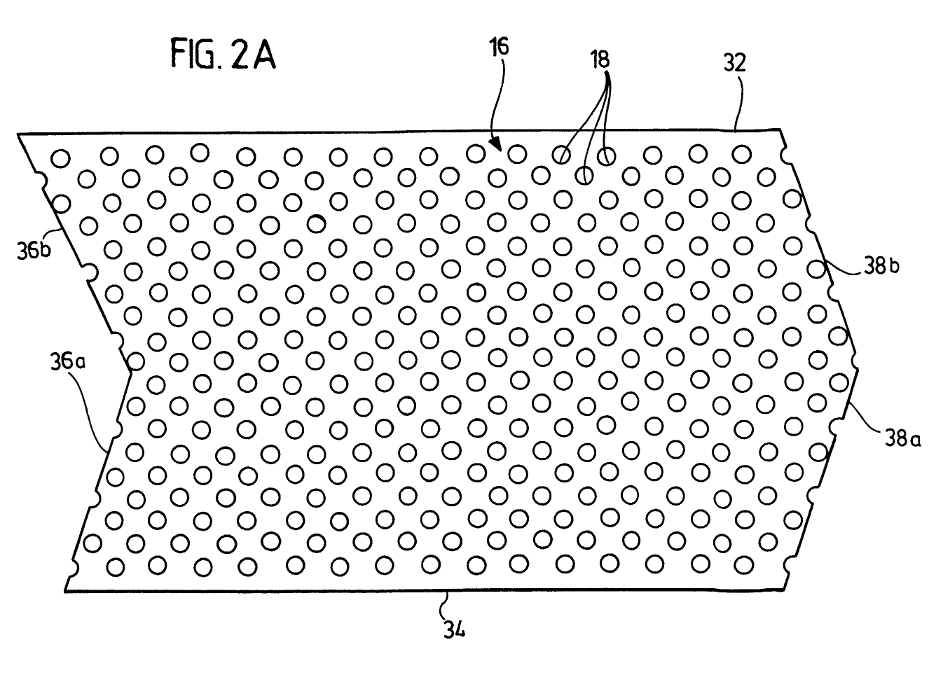

FIG. 2 shows a blank for the perforated plate shown in FIG. 1, and

FIG. 2A shows a blank for the perforated plate shown in FIG. 1A.

FIG. 1 diagrammatically depicts a filter element, which is denoted overall by the reference numeral 10, according to a first embodiment of the invention. This element comprises a hollow cylindrical support tube 12, the cylinder axis of which forms a longitudinal axis 14 of the filter element 10. The support tube 12 has been rolled up from a perforated plate 16 and has a multiplicity of flow openings 18.

A hollow-cylindrical filter material, in the form of a filter bellows 20, which has been produced in the customary way from a filter paper folded into a star shape, is arranged on the outer lateral surface of the support tube 12.

At its lower end, the filter element 10 has a fluid-tight lower closure cap 22, the outer edge region of which is bent upwards, towards the filter bellows 20, coaxially with respect to the longitudinal axis 14 and which surrounds a lower edge region of the filter bellows 20. By means of an adhesive, for example an epoxy resin adhesive, the lower closure cap 22 is connected in a fluid-tight manner to the lower edge region of the filter bellows 20 and to the support tube 12.

At its upper end, the filter element 10 has an upper closure cap 24. This comprises a holding ring 26 which is bent coaxially downwards, towards the filter bellows 20, surrounds the upper edge region of the filter bellows 20 and, in the region of the support tube 12, defines a central, circular outlet opening 28, which is adjoined, coaxially with respect to the longitudinal axis 14 and on the opposite side from the support tube 12, by a connection piece 30 which is integrally connected to the holding ring 26.

In a corresponding manner to that in which the lower closure cap 22 is fixed, the upper closure cap 24 is also connected in a fluid-tight manner, by means of an adhesive, to the upper edge region of the filter bellows 20 and to the support tube 12.

As has already been mentioned, the support tube 12 is produced by rolling up the perforated plate 16. For this purpose, the perforated plate 16 is cut into the shape of a parallelogram, as illustrated in FIG. 2. It comprises an upper edge 32 and a lower edge 34, which form the end sides of the support tube 12 and are oriented parallel to one another, and first and second longitudinal edges 36 and 38 which are oriented obliquely with respect to the upper and lower edges. If the perforated plate 16 which has been cut into the shape of a parallelogram is rolled up about the longitudinal axis 14, which runs perpendicular to the upper and lower edges 33 and 34, respectively, to form the support tube 12, the two longitudinal edges 36 and 38, as can be seen from FIG. 1, form a helical joint 40 which runs along the support-tube wall and is formed by the longitudinal edges 36 and 38 of the perforated plate 16, which come into contact with one another in the circumferential direction of the support tube 12. The helical joint 40 imparts a high mechanical stability to the support tube 12 without it being necessary for the two longitudinal edges 36 and 38 to be welded together. In this case, the helical joint 40 runs only over a partial region of the circumference of the support tube 12, preferably over an angular region of 120°. It has been found that a configuration of the joint of this nature makes it possible to achieve a particularly high stability of the support tube 12 and therefore of the filter element 10.

A second embodiment of the invention is illustrated in FIGS. 1A and 2A. This embodiment differs from the embodiment explained above with reference to FIGS. 1 and 2 only in that a perforated plate which is configured in the shape of an arrow is used for the support tube instead of a parallelogram-shaped perforated plate. Therefore, identical components are denoted by the same reference numerals as those used in FIGS. 1 and 2.

In the embodiment of the filter element illustrated in FIG. 1A, the support tube 12 likewise has a helical joint 40. Unlike the embodiment illustrated in FIG. 1, however, the joint 40 has a left-handed region and a right-handed region. This ensures that the joint does not shift in the direction of the longitudinal axis 14 in particular when subjected to high pressure loading and/or in the event of pressure fluctuations.

The left-handed and right-handed regions of the helical joint 14 are produced as a result of the perforated plate 16 . as illustrated in FIG. 2A being cut into the shape of an arrow, in such a manner that the longitudinal edges each have two sections 36a and 36b and 38a and 38b which are obliquely oriented with respect to one another. In this case, the first regions 36a and 38a and the second regions 36b and 38b are in each case oriented parallel to one another and in each case form a right-handed and left-handed region, respectively, of the helical joint 40. Naturally, as an advancement of the invention, it is possible to provide that, instead of a single left-handed and a single right-handed region, a plurality of left-handed and right-handed regions are provided for the helical joint 40.

In both embodiments of the filter element according to the invention which have been explained above, the fluid to be filtered flows through the filter bellows 20 in the radial direction from the outside inwards during filtration of the fluid, and can pass via the flow openings 18 into the interior of the support tube 12 and, from there, can leave the filter element 10 via the outlet opening 28. The pressure drop which forms at the filter element 10 during this flow through the filter element causes a considerable load on the support tube 12 in the radial direction. In this case, it is ensured by the helical configuration of the joint 40 that the support tube 12 withstands the load without it being necessary for the two longitudinal edges 36 and 38 of the perforated plate 16 to be welded together. The filter element 10 can therefore be produced at low cost and is distinguished by an improved environmental compatibility, since it is possible to dispense with energy-intensive welding.

1. Filter element, in particular for the filtration of mineral oils in hydraulic systems, having a filter material and a support tube which supports the filter material and is formed from a perforated plate with a multiplicity of flow openings, characterized in that the support tube (12) has a joint (40) which extends helically along the support-tube wall and is formed by those edges (36, 38) of the perforated plate (16) which are in contact with one another in the circumferential direction.

2. Filter element according to claim 1, characterized in that the joint (40) extends only over a partial region of the circumference of the support tube (12).

3. Filter element according to claim 1, characterized in that the joint (40) extends at most over half the circumference of the support tube (12).

4. Filter element according to claim 1, characterized in that the edges (36, 38) of the perforated plate (16) are in contact with one another without an overlap in the region of the joint (40).

5. Filter element according to claim 1, characterized in that the pitch of the helical joint (40) is partially left-handed and partially right-handed (36a and 36, respectively).
